(19) United States
(12) Patent Application Publication
(10) Pub. No.: US 2008/0090630 A1
(43) Pub. Date: Apr. 17, 2008

(54) GAMING MACHINE AND GAMING METHOD THEREOF

(75) Inventor: Kazumasa YOSHIZAWA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 11/862,715

(22) Filed: Sep. 27, 2007

(30) Foreign Application Priority Data
Oct. 12, 2006 (JP) 2006-278275

(51) Int. Cl. A63F 13/00

(52) U.S. Cl. 463/13

(57) ABSTRACT

A gaming environment is described. Dealer cards and player cards are dealt from a card deck. Each of dealer cards and player cards are arranged into high hand and low hand. Each of high hand and low hand is compared, and a game result is determined. If a player wins a game and the player cards include any of special images, an award corresponding to the special image will be provided in addition to a normal award.

### CROSS-REFERENCE TO RELATED APPLICATIONS

This application is based upon and claims a priority from the prior Japanese Patent Application No. 2006-278275 filed on Oct. 12, 2006, the entire contents of which are incorporated herein by reference.

### BACKGROUND

1. Field

One or more aspects of the present invention relate to a gaming machine in which games are conducted in accordance with cards displayed on a display and input information of players, and a gaming method thereof. More particularly, one or more aspects of the present invention relate to the game machine and the gaming method thereof that if winning cards include a special image, an award to be provided is beneficially changed.

2. Description of Related Art

Conventionally, at casinos, game arcades and the like, card game machines and tables, in which a dealer and plural players play card games, are installed. The played card games include Pai Gow Poker, Draw Poker, Blackjack, or the like. The card games are played with the use of card having marks (for example, Ace-hearts). Content of an award to be provided to the player is determined based on cards or hand which is dealt to the player and cards or hand which is dealt to the dealer.

In Pai Gow Poker, seven cards are dealt to the dealer and plural players (six players at maximum), and the dealer and the players assemble a two card and a five card from seven cards. Each hand displayed on cards is compared, and then a game result and award are determined based on the compared result.

In some conventional examples of card game machines and gaming method thereof, if the player wins against the dealer, the award is provided. Here, the award is predefined based on kinds of player hand which is dealt to the player (for example, Straight Flush, Full House).

Consequently, the player may anticipate the award to be provided in current game when cards are dealt. Also, if the player hand is not good, the sense of anticipation for higher award will be less. Accordingly, the player's interest of the game will attenuate.

### SUMMARY

One or more aspects invention related to a gaming machine, a gaming method thereof, a computer readable medium having computer-executable instructions or the like which provide higher award than player hands displayed on a display. Also, one or more aspects of the present invention, each of dealer cards and player cards are arranged into high hand and low hand. Each of high hand and low hand is compared, and a game result is determined. If a player wins a game and the player cards include any of special images, an award corresponding to the special image will be provided in addition to a normal award. Also, one or more aspects of the present invention enhance the player's sense of the anticipation for the game. Also, in one or more aspects of the present invention, the payout ratio will be easily changed.

One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a view showing a bet screen displayed on a display of a terminal in accordance with one or more aspects of the present invention.

FIG. 2 is a perspective view showing a card game machine in accordance with one or more aspects of the present invention.

FIG. 3 is a perspective view showing a terminal in accordance with one or more aspects of the present invention.

FIG. 4 is a block diagram schematically showing a control system of the card game machine.

FIG. 5 is a block diagram schematically showing a control system of the terminal.

FIG. 6 is a view showing a bet screen displayed on a display of the terminal in accordance with one or more aspects of the present invention.

FIG. 7 is a view showing a bet screen displayed on a display of the terminal in accordance with one or more aspects of the present invention.

FIG. 8 is a view showing special images and awards to be changed which are included in player cards.

FIG. 9 is a view showing display colors and award to be changed which are included in the player cards.

FIG. 10 is a view showing a main screen displayed on a front display.

FIG. 11 is a part of a flowchart of a game process executed in the card game machine.

FIG. 12 is the part of the flowchart of the game process executed in the card game machine.

FIG. 13 is the view showing a table game which is applied to one or more aspects of the invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention as a card game machine. However, it is appreciated that one or more aspects of the present invention may be embodied in distributable (via CD and the like) or downloadable software games, console games, and the like. In this regard, the card game machine may be a virtual card game machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware.

These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server. It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

An embodiment embodying a gaming machine in one or more aspects of the invention as a card game machine will be described in detail with reference to the drawings below. The card game machine of the embodiment is a type of multi-player game machines that have plural terminals. Here, each of the terminals may accept input information from the players. In the card game machine, PAI GOW Poker, which is a type of a card game, may be conducted. In PAI GOW Poker, at first, each of the players bets a predetermined amount of tips, and then, each of the players arranges seven cards dealt as player hand into a two-card (low hand) and a five-card (high hand). And then, the player hands are compared with the dealer hands. If player's high hand and low hand are both higher than dealer's ones, it is determined that the player wins, and the award corresponding to the bet value will be provided.

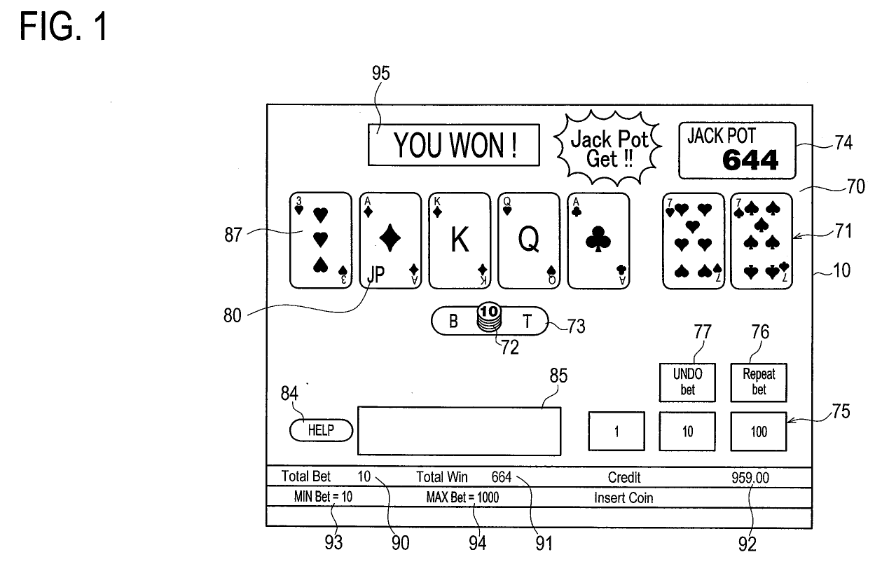

Also, the card game machine of one or more aspects of the invention, if player's winning cards include special image, the award to be provided will be beneficially changed. For example, as shown in FIG. 1, if seven player cards include the card displaying an image 80 having a text of “JP” as a special image, JACKPOT will be won and pooled amount accumulatively stored until now in a pot will be provided, in addition to the award corresponding to the bet value.

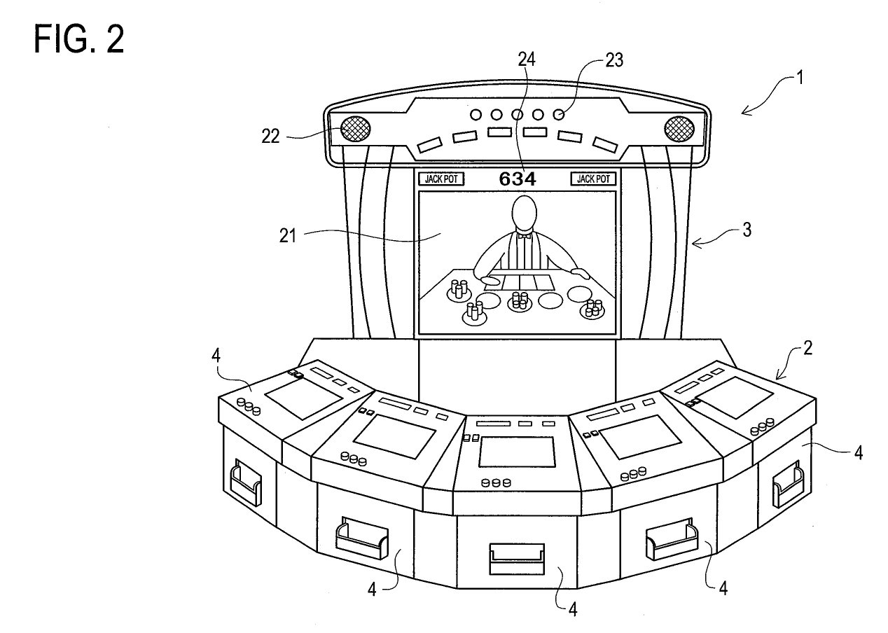

At first, a simple construction of the card game machine 1 of the embodiment will be described with reference FIG. 2. FIG. 2 is a perspective view of the card game machine 1 of the embodiment. The card game machine 1 of the embodiment may basically include table portion 2, a panel portion 3. The players sit around the table portions 2 and play games with the use of the table portions 2. The panel portion 3 is arranged behind the table portions 2. Virtual dealer's animation images or the like are displayed on the panel portion 3.

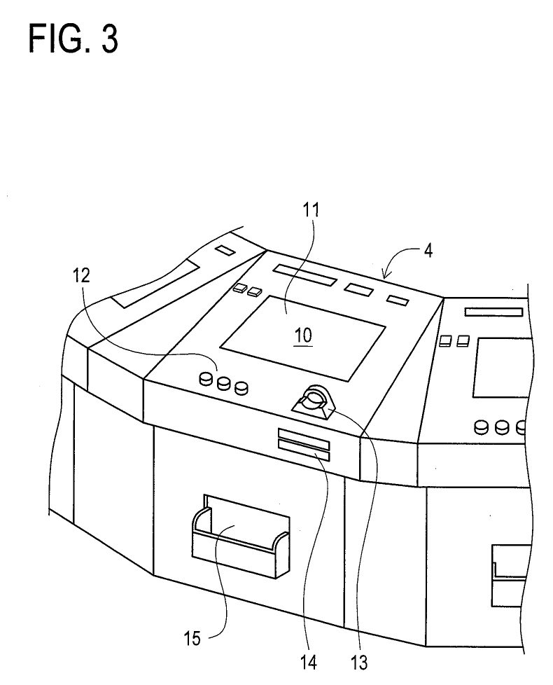

At first, the table portion 2 will be described. On the table portion 2, plural terminals 4 (in FIG. 2, five terminals) called a satellite are arranged with almost fan-shape. FIG. 3 is a perspective view of one terminal 4 of the embodiment.

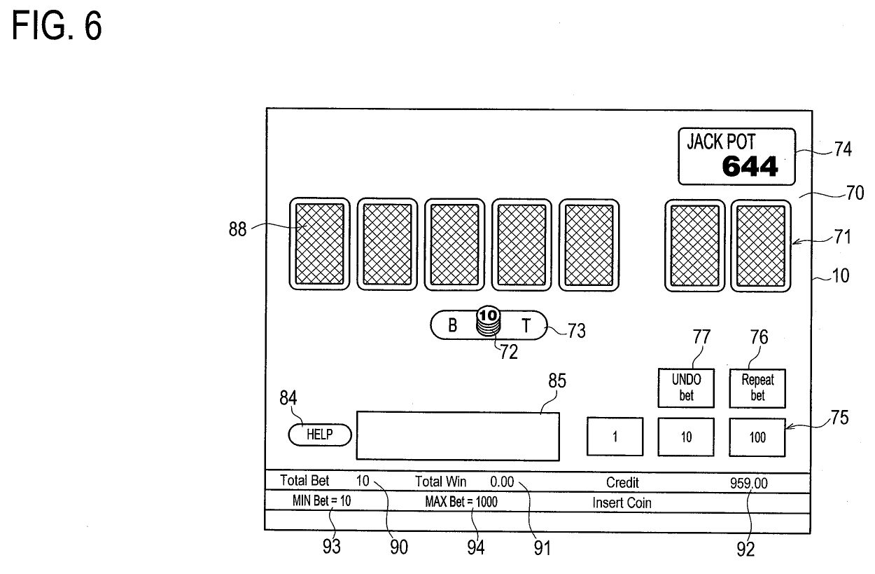

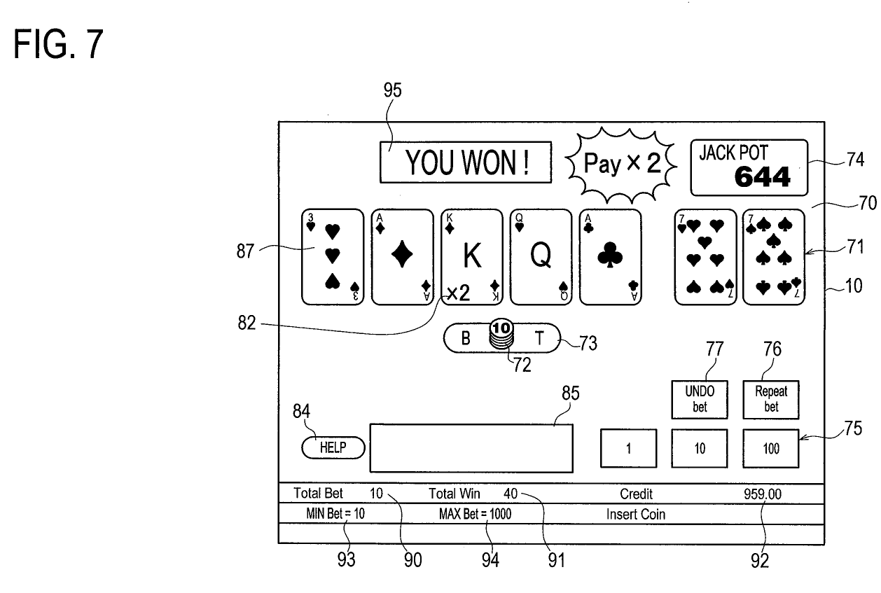

As shown in FIG. 2, the terminal 4 includes liquid crystal display 10, a touch panel 11, an operation button 12, a coin insertion portion 13, a bill insertion portion 14, and a coin tray 15. Abet screen (see FIGS. 6 and 7) which will be described later and game result or the like are displayed on the liquid crystal display 10. The touch panel 11 is arranged in front of the liquid display 10. The touch panel 11 is used when the player selects a button displayed on the liquid crystal display 10 at a choice operation of bet object or setting bet value. The operation button 12 is used when the player operates a payout or the like. The coin or the medal are inserted the coin insertion portion 13. The bills are inserted to the bill insertion portion 14. When the operation of payout is made, the coins or the medals corresponding to accumulated credit are provided to the player through the coin tray 15.

A panel portion 3 includes a front display 21, a loud speaker 22, and LED 23. The dealer image that deals the cards and exchanges chips, and contents of dealt cards are displayed on the front display 21. The loud speaker 22 is arranged on the top of the front display 21, and outputs a music and sound effect according to the game session.

A JP amount display portion 24 may be arranged on the upper portion of the front display 21. In the card game machine 1 of the embodiment, 5% of the bet value will be pooled in the pot. Here, the portion of the bet value is variable. If the player wins against the dealer and player hand includes the card displaying the image 80 having the text of “JP”, JACKPOT will be won, pooled amount will be provided at one time. Here, the pooled amount currently pooled in the pot is displayed in the JP amount display portion 24.

The cards used in the card game machine 1 include commonly playing card. Mark is displayed on each of the cards (see FIG. 1). The mark has suit and number.

The suits mean the mark of the playing card and include four kinds such as spades, hearts, diamonds, and clubs.

The numbers mean number or alphabetic character include thirteen kinds such as “A” (equivalent of “1”), “2”, “3”, “4”,““5”, “6”, “7”, “8”, “9”, “10”, “J” (equivalent of “11”), “Q” (equivalent of “12”), and “K” (equivalent of “13”).

The mark is the kinds of the playing card and defined by a combination of the suit and the number. For example, the marks include Ace-hearts, King-spades, or the like. Also, one (a single) card deck has fifty-three cards. The fifty-three cards include fifty-two cards and joker. Each of the fifty-two cards is defined by a combination of the suit (four kinds) and the number (thirteen kinds).

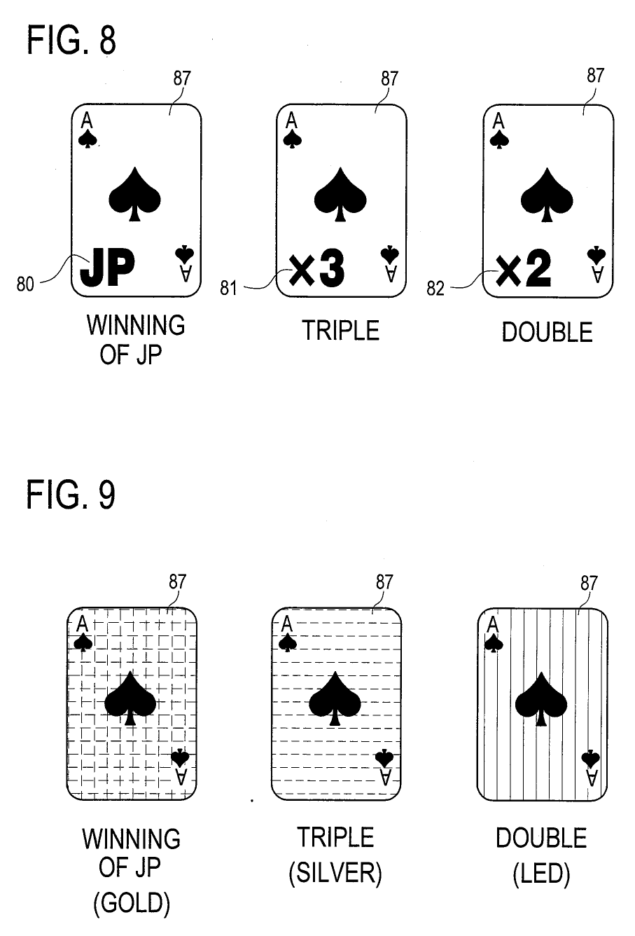

A method of the card game machine 1 making up mentioned above will be described. At first, the players sit in front of the terminal 4 and bet desired bet value with the use of the bet screen displayed on the liquid display 10. After that, images of player's cards and dealer's cards dealt to the player and the dealer respectively, and an operation of that arrangement of high hand and low hand is conducted. After that, effect image indicates that either the player or the dealer wins or draw. The effect to be displayed is based on the kinds of the marks. On the each of the terminal 4, if the player wins the dealer, double bet value (credit count) which was betted will be provided. On the other hand, if the dealer wins against the player, none of the award will be provided. If the player makes a draw with the dealer, the bet value which was betted will be paid back to the player. If the player wins the game and player cards include the card having special image (which will be described later, see FIG. 8) or the card which is displayed with different color (for example, gold color) from other cards, the award to be provided will be beneficially changed.

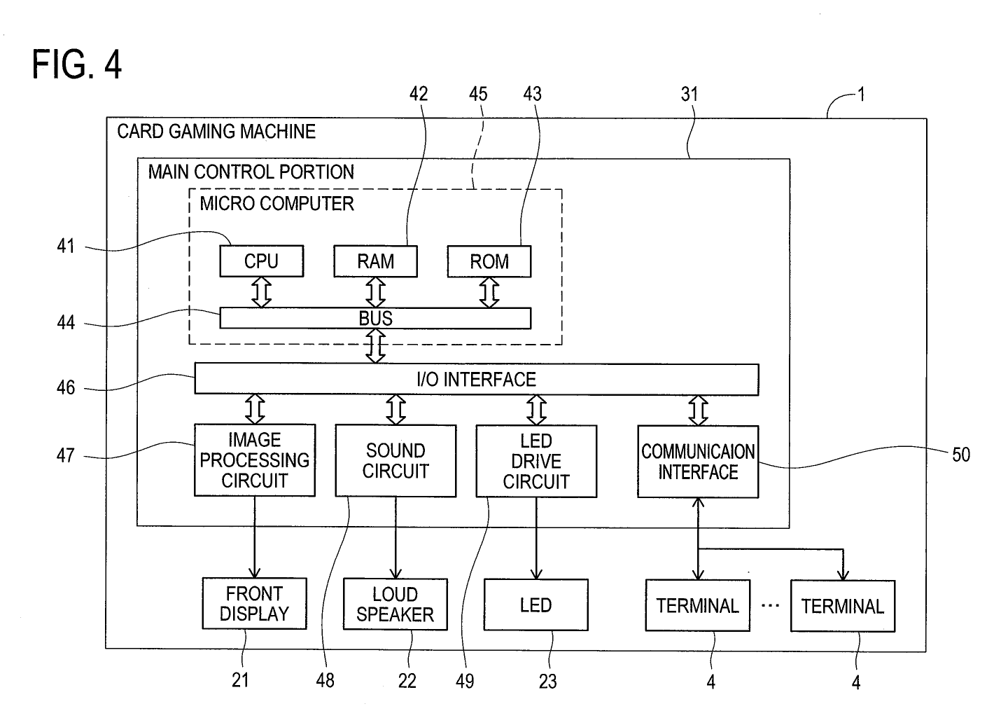

A construction of a control system of the card game machine 1 will be described with reference to FIG. 4. FIG. 4 is a block diagram schematically showing the control system of the card game machine 1 of the embodiment.

As shown in FIG. 4, the card game machine 1 of the embodiment includes a main control portion 31, plural terminals 4, and various peripheral devices. The plural terminals 4 and the various peripheral devices are connected to the main control potion 31.

The main control portion 31 may basically include a microcomputer as a core. The microcomputer includes a CPU 41, RAM 42, ROM 43, and a bus 44. Data is transferred each other via the bus 44. In the ROM 43, various programs, data tables, and the like, which are used to execute for controls of the card game machine 1, are stored. In the RAM 42, various data operated by the CPU 41 is temporarily stored. In the ROM 43, top-side images and back-side images, which are used on the player cards and the dealer cards, are also stored. Also, in the card game machine 1, the special image having a text of “JP” or the like are also stored

The CPU 41 is connected to a image processing circuit 47, a sound circuit 48, a LED drive circuit 49, a communication interface 50 via a I/O interface 46.

The main control portion 31 receives the bet operation information (such as bet value) by the player, from the each of the terminals 4. And then, the main control portion 31 determines whether or not the condition of game-start is met. When the game is started, seven cards of fifty-three cards are associated with the player and the dealer (in the screen, the seven cards are dealt to the player and the dealer). And then, the game result (any of player's win, dealer's win, or draw) is determined based on the associated cards of the hand, the game result will be sent to each terminal 4. Each of the terminals 4 increases or decreases stored credit based on the game result which is received by the main control portion 3.

And, the control portion 31 drive-controls the output of image signal to be displayed on the front display 21, the loud speaker 22, and the LED 23.

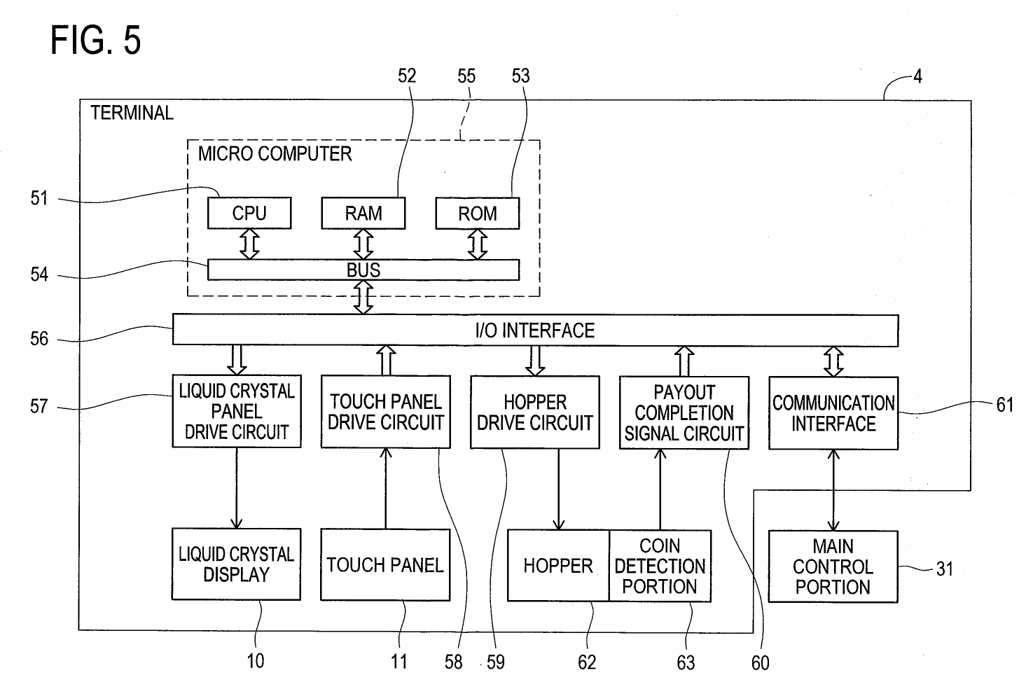

A construction of control system of the terminal 4 will be described with reference to FIG. 5. FIG. 5 is a block diagram schematically showing the control system of the terminal 4 of the embodiment.

As shown in FIG. 5, the terminal 4 of the embodiment is basically includes a microcomputer 55 as a core. The microcomputer includes a CPU 51, RAM 52, ROM 53, and bus 54. Data is transferred each other via the bus 54. In the ROM 53, various programs, data tables, and the like, which are used to execute for controls of the terminal 4, are stored. In the RAM 52, the credit count currently stored in the terminal 4, the bet object which is bet by the player, the bet value (credit count) which the player bets the bet object, odds, and various data operated by the CPU 51 are temporarily stored.

The CPU 51 is connected to a liquid crystal panel drive circuit 57, a touch panel drive circuit 58, a hopper drive circuit 59, a payout completion signal circuit 60, and a communication interface 61 via the I/O interface 56. The liquid display 10 is connected to the liquid panel drive circuit 57. The touch panel 11 is connected to the touch panel drive circuit 58. The hopper 62 is connected to the hopper drive circuit 59. The coin detection portion 63 is connected to the payout completion signal circuit 60.

The CPU 51 calculates the bet value which is betted by the player based on the operation information which is output from the touch panel 11. And then, the calculated bet value will be stored in the bet value storage area of the RAM 52 and will be sent to the main control portion 31. Also, the CPU 51 increases and decreases the stored credits based on the game result which is sent by the main control portion 31.

And, the CPU 51 controls output for image signal corresponding to the image to be displayed on the front display 21, a paying out of coins from the coin tray 15 based on the hopper 62 and the coin detection portions 63.

A bet screen 70 will be described with reference to FIGS. 6 and 7. If the player plays PAI GOW Poker in the card game 1 of the embodiment, the bet screen 70 is displayed on the liquid display 10 of the terminal 4.

FIGS. 6 and 7 show a bet screen 70 displayed on the liquid display 10 of the terminal 4. Here, in the card game machine 1 of the embodiment, the player conduct bet operation with the use of the bet screen 70 and the touch panel 11. Also, the player conducts the operation of arrangement of the high hand and low hand.

As shown in FIGS. 6 and 7, the bet screen 70 includes a player cards display area 71, a tip display area 73, a pooled amount display area 74, and an information display area. In the player cards display area 71, the top-side image 87 and the back-side image 88 are displayed. In the tips display area 73, the tips image 72 corresponding to bet value is displayed. In the pooled amount display area 74, pooled amount pooled in the pot is displayed. In the information display area, various operation buttons and information of player are displayed.

The top-side image 87 and the back-side image 88 of the player cards dealt to the player may be displayed in the player cards display area 71. When the player cards are dealt to the player, the back-side image 88 is displayed (see FIG. 6). While the back-side image 88 is displayed, the marks of the cards are invisible. And then, the top-side image 87 is displayed (see FIG. 7). When the top-side image 87 is displayed, the marks of the cards are visible. Here, images 87 and 88 of seven cards displayed in the player card display area 71 become the cards dealt to the player who sits around the terminal 4. The dealt cards will be freely split into five-card (high hand) and two-card (low hand) within the house rule. The player splits the cards by operating the touch panel 11.

Especially, in FIGS. 6 and 7, five cards located on the right side of the bet screen 70 are arranged into the high hand, two cards located on the left side of the bet screen 70 are arranged into the low hand. The player can change the allocation of the high hand and low hand by arranging the seven cards displayed in the player cards display area 71.

In the card game machine 1 of the embodiment, the card having the special image can be dealt. If the card having the special image is dealt as the player card (namely, special image is displayed any of the top-side image 87 of cards displayed in the player cards display area) and the player won against the dealer in current game, the award to be provided will be beneficially changed. Here, FIG. 8 shows special images and indications of changes of award.

For example, as shown in FIG. 8, if the player wins with the player card of the image 80 having the text of “JP” as the special image in the game, the amount pooled in the pot will be provided, in addition to the award corresponding to normal bet amount.

Also, if the player wins with the player card displayed the special image 81 having the text of “x3”, the award to be provided will be tripled and tripled amount will be provided.

Also, if the player wins with the player card displaying the special image 82 having the text of “x2”, the award to be provided will be double and doubled amount will be provided.

Here, in other condition than that special image are displayed, if the card having different color from other cards is dealt (namely, the color of the top-side image 87 and the back-side image 88 of the dealt cards displayed in the player cards display area 71 is different from other cards) to the player and the player wins in current game, the award to be provided will be beneficially changed.

As shown in FIG. 9, for example, if the player wins with the player card having gold color, the amount pooled in the pot will be provided, in addition to the award corresponding to normal bet amount.

Also, if the player wins with the player card having silver color, the award to be provided will be tripled and the tripled amount will be provided.

Also, if the player wins with the player card having red color, the award to be provided will be doubled and the doubled amount will be provided.

Here, player cards include plural cards having the special images, the award will be beneficially changed more higher. For example, the card displaying the image 81 of “x3” and the image 82 of “x2”, the normal award will be multiplied by six, and multiplied amount may be provided.

The chip image 72 corresponding to the bet value of player may be displayed in the chip display area 73. For example, in FIGS. 6 and 7, tips of ten credits are betted. The player selects the bet value with the use of the bet button 75. The player fixes the bet value by touching the tips display area 73. And then, fixed bet value will be sent to the main control portion 31.

The pooled amount which is pooled in the pot may be displayed in the pool amount display portion 74. In the card game machine 1, a predetermined portion of bet value is pooled in the pot. Here, the predetermined portion of bet count is variable. The predetermined portion may or may not be 5%.

Bottom-right side of the chips display area 73, plural bet buttons 75 (in the embodiment, three types of “1 credit”, “10 credits”, and “100 credits”) may be arranged. The player can select the bet value to be betted on the current game by touching the bet button 75

Above the bet button 75, a Repeat bet button 76 and an UNDO bet button 77 may be arranged. The player can bet previous bet value by touching the Repeat button 76. Also, the player can undo the bet operation which is already conducted by touching the UNDO bet button 77.

Bottom-left side of the chip display area 73, a HELP button 84 may be arranged. If the player wants to display the manner of operation on the liquid display 10, the player will touch the HELP button 84. On the right side of the HELP button 84, in the comment display portion 72, the massages, which support the game sessions, are displayed.

On the lower side of the player cards display area 71, a bet value display area 90 and a win amount display area 91 and credit display area 92, minimum bet value display area 93, and maximum bet value area 94 may be displayed. The bet value which is betted by the player in current game is displayed in the bet value display area 90. The award amount is displayed in the win amount display area 91. The credit count in which the player currently own is displayed in the credit display area 92. An available minimum bet value is displayed in the minimum bet value display area 93. An available maximum bet value is displayed in the minimum bet value display area 94.

The game result display area 95 is arranged on the left side of player cards display area 71. The game result of current game may be displayed in the game result display area 95. In Pai Gow Poker, either the dealer or the player, whose high hand and low hand both higher in rank, is winner. Also, other than that, the current game is tie (draw). Here, if the game is draw, the text of “DRAW” may be displayed in the game result. If the player wins the game, the text of “YOU WON” may be displayed. Also, if the player loses the game, the text of “YOU LOST” may be displayed.

Further, if the player wins the game with the card having the special image, the content of the additional award will be displayed based on the special image.

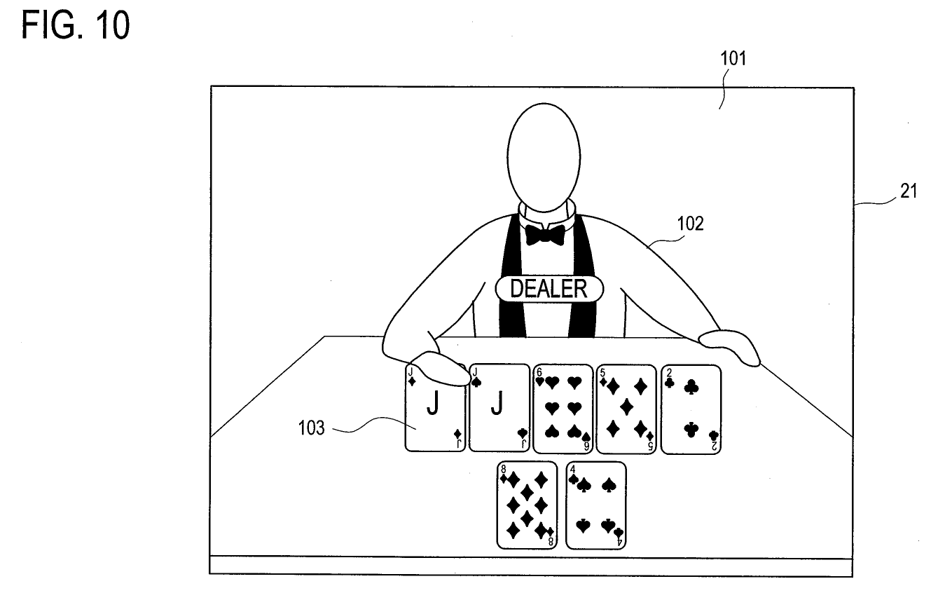

The main screen 101, which is displayed on the front display 21 when PAI GOW Poker executed in the card game machine 1 of the embodiment, will be described with reference to FIG. 10.

FIG. 10 shows the main screen 101 displayed on the front display 21. Here, in the card game machine 1 of the embodiment, to enhance the feeling of being a real thing, virtual dealer images 102, which acts animations such as dealing of cards, are displayed on the main screen 101 according to the game session.

Images 103 of the dealer cards, which are dealt to the dealer as dealer hand, displayed on almost center of the main screen 101. In the card game machine 1 of the embodiment, seven cards are dealt to the dealer as the dealer cards the same as the player cards. The dealer cards are arranged into high hand and low hand in accordance with the house rule, and displayed on the main screen 101 (for example, in FIG. 10, high hand of five cards are displayed on upper side, and low hand of two cards are displayed on lower side)

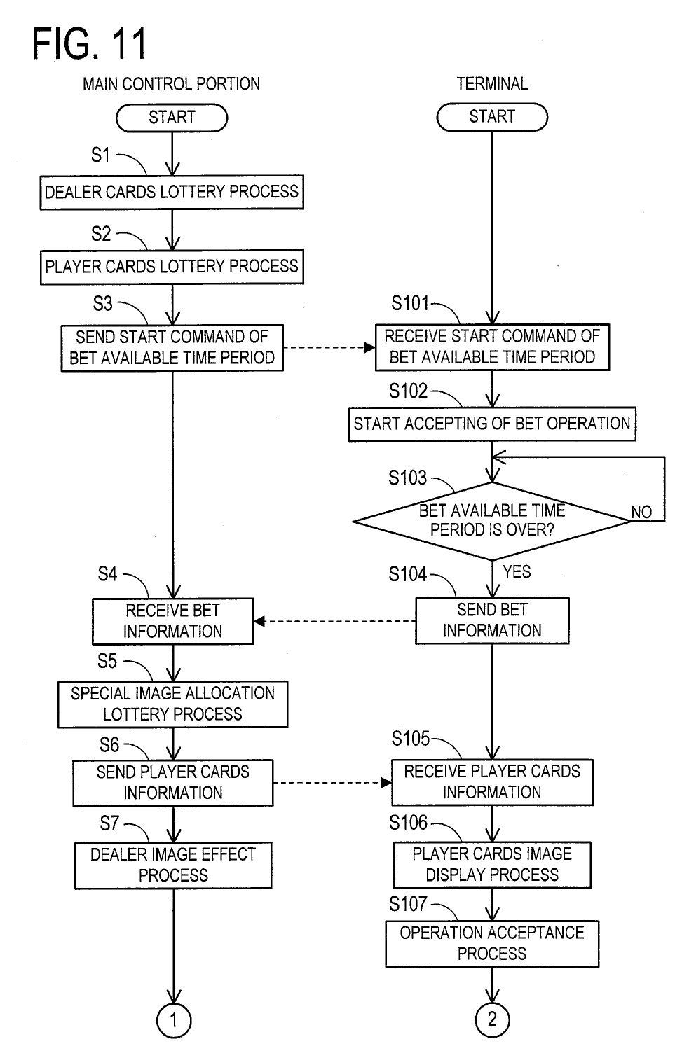

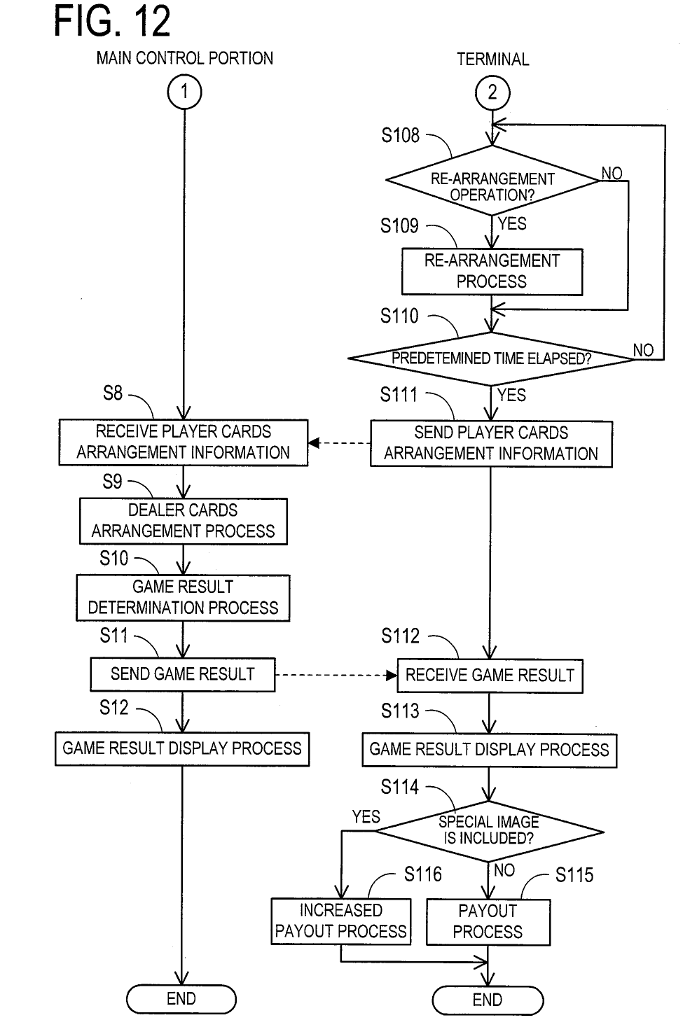

The game process program executed by the CPU 41 of the main control portion 31 on the card game machine 1 of the embodiment having above construction, and the game process program of the terminal 4 side executed by the CPU 51 of the terminal 4 will be described with reference to FIGS. 11 and 12. Each of the programs shown in FIGS. 11 and 12 are stored in the RAM 42 and the ROM 43 mounted on the main control portion 31, and the RAM 52 and the ROM 53 mounted on the terminal 4. The programs are executed by the CPU 41 or the CPU 51.

The game process program executed by the main control portion 31 will be described with reference with FIGS. 11 and 12. In S1, the CPU 41 executes the dealer cards lottery process. In the dealer cards lottery process, the dealer cards of dealer hand is determined by lottery. Concretely, in a case where there are N cards as one card deck (in Pai Gow Poker, N=53), each of the cards making up the card deck is associated with one number among any of 1 to N. In S1, seven numbers are determined among from 1 to N, and seven cards corresponding to the seven numbers (namely, seven cards are dealt to the dealer.) will be dealer cards.

In S2, the CPU 41 executes the player cards lottery process. In the player cards lottery process, player cards are determined by lottery. Concretely, forty-six cards of fifty-three card are associated with one number among any of 1 to 46. Here, dealt seven cards are excepted from the fifty-three card, at result, forty-six cards are determined. Seven cards corresponding to the seven numbers will be player cards (namely, seven cards are dealt to the player).

In S3, the CPU 41 sends a start command to each of the terminals 4. The start command instructs each of the terminals 4 to start a bet available time period. During the bet available time period, the players can bet.

In S4, the CPU 41 receives bet information which is send from each of the terminal 4. The bet information includes the information related to the bet value (credit count) which is betted by each of the player. The received bet information of each of the terminal 4 will be temporarily stored in the RAM42.

In S5, the CPU 41 executed the lottery process. In the lottery process, it is determined whether or not seven player cards will include any of the special images 80 to 82. Concretely, the CPU 41 generates the random number value among predetermined range of the random number values by executing the random number generation program. It is determined whether or not any of one or more image 80 of “JP”, image 81 of “x3”, image 82 of “x2” are included in player cards by lottery. The lottery table will be changed based on the bet value. That is, larger bet count will be higher probability of including for the special images.

In S6, the CPU 41 sends the information of seven player cards (such as information related to kinds of mark (for example, 7-herats, Ace-spaces, or the like) and information related to special images (for example, “JP”, “x3”, or the like)) to each of the terminal 4 based on the lottery result. The lottery result includes the lottery result in the player cards lottery process of S2 and whether or not the special image is included in S5. In S7, dealer image, which deals cards to the players and the dealer, is displayed on the front display 21 as the main screen 101 (see FIG. 10). When the dealer cards are dealt to the dealer, the back-side image is displayed, and the kinds of the mark and special image are invisible.

In S8, the CPU 41 receives the arrangement information of the high hand and low hand of the player cards which is sent from the terminal 4. In the card game 1 of the embodiment, the player can arrange into high hand of five cards and low hand of two cards within the house rule.

In S9, the CPU 41 splits seven dealer cards into high hand and two hand within the house rule. Also, the dealer cards displayed on the main screen of front display 21 are changed from the back-side image to the top-side image, at result, high hand and low hand of the dealer cards are displayed (see FIG. 10).

In S10, the CPU 41 compares the player's high hand with the dealer's one, and player's low hand with the dealer's one. At result, the CPU 41 determines the game result. Concretely, the game result is determined based on the hand, if dealer's high hand and low hand are both higher rank than the player's ones, the dealer will be winner. On the other hand, if player's high hand and low hand are both higher than the dealer's ones, the player will be winner. Also, other than that, the current game is tie. Here, the kinds of hands of PAI GOW poker are well known, so the explanation of that will be omitted.

In S11, the game result in S10 may be sent to each of the terminals 4. In S12, the CPU 41 displays a game result image indicating the game result on the main screen 101 of the front display 21.

The game process program executed by the terminal 4 will be described with reference to FIGS. 11 and 12. In S101, the CPU 51 received the information instructing to start a bet available time period.

In S102, the CPU 51 displays the bet screen 70 (see FIGS. 6 and 7) on the liquid display 10, and determines the bet amount based on the operation information from the touch panel 11.

In S103, the CPU 51 determines whether or not the bet available time period is over. Concretely, the predetermined time period (for example, 20 seconds) from the timing of that the bat operation is available in S102 is elapsed.

If it is determined that the bet available time period is not over (S103:NO), the bet operation is available continuously. On the other hand, if it is determined that the bet available time period is over (S103:YES), the procedure will be shifted to S104.

In S104, the CPU 51 sends the bet information to the main control portion 31. Here, the bet information may include bet count (credit).

In S105, the CPU 51 receives the information of the player card (such as information related to kinds of mark (for example, 7-herats, Ace-spaces, or the like) and information related to special images (for example, “JP”, “x3”, or the like)) from the main control portion 31. In S106, the CPU 51 displays the player cards on the bet screen 70. Here, the player cards are displayed with back side image 88. That is, the marks of the player cards are invisible. And then, when a predetermined time (for example, 3 seconds) is elapsed, the player cards are displayed with top-side image (see FIG. 7). Thereby, the marks of the player cards are visible. If it is determined that any of the dealt player cards include any of the special image 80 to 82 based on the lottery result of S5, the special images are displayed in addition to the top-side image.

The timing of displaying the special image 80 to 82 is not only the same timing of changing the back-side image 88 to the top-side image 87, but also the timing of that the predetermined time is elapsed from that the top-side image 87 is displayed.

In S107, the CPU 51 starts the condition where operation of change for arrangement of high hand and low hand. In S108, it is determined whether or not operation of change for arrangement. If it is determined that operation of change for arrangement is conducted (S108:YES), the kinds of high hand and low hand, and allocation of the card will be changed (S109).

On the other hand, if it is determined that the operation is not conducted (S108:NO), the procedure will be shifted to S110.

In 110, it is determined whether or not the predetermined time (for example, 15 seconds) is elapsed from that the operation available process was started. If it is determined that the predetermined time is elapsed (S110:YES), the arrangement information of the high hand and the low hand of the currently player cards, to the main control portion 31 (S111). On the other hand, if it is determined that the predetermined time is not elapsed (S110:NO), the procedure will be shifted to S108

In S112, the CPU 51 receives the game result which is sent from the main control portion 31. In S113, the game result may be displayed on the liquid crystal display 10 of the terminal 4 based on the game result which is sent in S112. Concretely, if the game is draw, the text of “DRAW” is displayed in the game result display area 95 of bet screen 70 (see FIG. 7). If the player wins the game, the text of “YOU WON” is displayed in the game result display area. If the player loses the game, the text of “YOU LOST” is displayed in the game result display area. Also, if the player wins the game with the card having any of the special image 80 to 82, the contents of additional award will be displayed.

In S114, the CPU 51 determines whether or not the card having any of the special images 80 to 82 is dealt, based on the player card information which is received in S105.

If it is determined that none of special image 80 to 82 is included in the player cards (S114:NO), the normal award will be provided. Concretely, if the player wins against the dealer, double bet value will be provided, and if the game is draw, the bet value will be provided without change (S115).

On the other hand, if it is determined that any of special image 80 to 82 is included in the player cards (S114:YES), the award to be provided will be beneficially changed from a condition of S115. Concretely, the award to be provided will be changed to double or treble (S116). Further, if the player cards include the special image 80 having the text of the “JP”, JACKPOT will be won and the pooled amount stored in the pot will be provided, in addition to the normal award. Here, the pooled amount is provided, the pooled amount will be changed to staring value (for example, 100).

As mentioned above, in the card game machine 1 and game method thereof of the embodiment, the dealer cards and the player cards are dealt from the card deck, and then the game result is determined by comparing high hand and low hand (S10), if the player wins the game and the player cards include any of the special images 80 to 82, the award corresponding to the special image 80 to 82 will be provided (S116), in addition to normal award. Thereby, although the player hand is not high, the player can obtain higher award, so the sense of anticipation will be enhanced.

Also, adjustment of payout ratio may be easily changed, by changing the display image.

Further, if the player cards have different color from the other cards, the award will be changed, so the player can easily understand that the content of the award to be provided. Thereby, the player's sense of anticipation will be enhanced.

Here, aspects of the present invention are not limited to the above embodiment and various changes and modification can be done within the scope of the present invention.

For example, the special image 80 to 82 are displayed on the top-side image 87 of the player-card, however, the back-side may be displayed. The timing of displaying the special image 80 to 82 may be not only the timing dealing the player cards, but also the timing of determining the game result against the dealer,

In one or more aspects of the invention, if the player cards include any of the special images 80 to 82 and the player wins against the dealer, the award to be provided will be beneficially changed. However, one or more embodiments are not so limited. For example, if the player-card includes the special image 80 to 82, the player may be provided the award based on the special image even though the player lost.

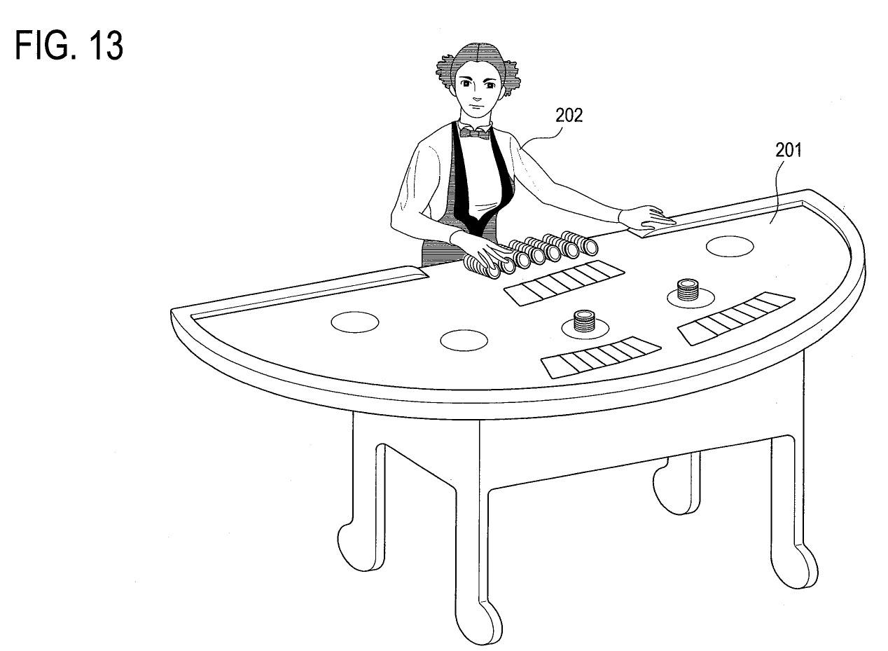

Also, the invention may be applied in the field where PAI GOW Poker (so-called table games) in which an actual dealer 202 and players (not shown) play on a game table (see FIG. 13).

In the table game shown in FIG. 13, the dealer has one card deck, and deals the dealer and each of the players on the playing table 201. And, one or more cards of the card deck have predetermined symbol (for example, “JP”, “x3”, “x2”, or the like). On the other hand, each player bet by placing the tips on predetermined position. If the player wins with the card having the special image, the award to be provided will be increased.

Here, a concrete game method is the same as the above embodiment, except that actual dealer who deals cards and exchanges tips.

Also, the card game machine and/or the card game method of one or more aspects of the invention may be applied to other than the PAI GOW Poker, for example, card games and methods thereof including Black Jack, or other poker and the like.

In a case where one or more present invention are applied to Black Jack or other pokers, if the terminal receives the input information of the player to add or change player cards, the card will be dealt as additional card or exchanged card among the cards other than the card already dealt to the player. Specially, in a case of Draw Poker, the rank of the winning (for example, Full House, Straight, Four of a Kind) may be based on the player hand, the award will be provided based on the rank of the winning. If the player hand includes any of the special images 80 to 82, the award corresponding to the rank of the winning will be provided with an increase.

Also, in a case the invention is applied to a table game shown in FIG. 13, if the player calls the additional card or change the card, the dealer will deal additional card or changed card among rest of the card without dealt cards. Thereby, although realized award is not high, the player can obtain higher award. Accordingly, the sense of anticipation for the game will be enhanced.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display that displays cards;
a operation portion that receives input information by a player; and
a controller;
wherein the controller is programmed to:
display the cards on the display,
conduct a card game based on the displayed cards and the input information by the player,
determine an outcome when the player won the card game, and
beneficially change the outcome when the player won the card game with a first predetermined card, the first predetermined card having a special image.

2. A gaming machine comprising:
a display that displays cards;
a operation portion that receives input information by a player; and
a controller;
wherein the controller is programmed to:
determine the cards, the card being displayed,
display the determined cards on the display,
add or change the card when an indication of an addition or a change of the card is made,
determine an outcome based on a rank of a winning when the player won the card game, and
beneficially change the outcome when the player won the card game with a first predetermined card, the first predetermined card having a special image.

3. A gaming machine comprising:
a display that displays cards;
a operation portion that receives input information by a player;
a bonus pool that accumulatively stores a portion of a bet value; and
a controller;
wherein the controller is programmed to:
display the cards on the display,
conduct a card game based on the displayed cards and the input information by the player,
determine an outcome when the player won the card game, and
beneficially change the outcome to an accumulated value stored in the bonus pool when the player won the card game with a first predetermined card, the first predetermined card having a special image.

4. The gaming machine according to claim 1, wherein the controller programmed to beneficially change the outcome when the player won the card game with a second predetermined card, the second predetermined card having a different color from another cards

5. A gaming method comprising:
dealing at least one card among plural cards to a player;
conducting a card game based on the dealt card;
determining an outcome when the player won the card game; and
beneficially changing the outcome when the dealt card has a predetermined symbol.

6. A gaming method comprising:
dealing at least one card among plural cards to a player;
adding or changing the card when an indication of an addition or a change of the card is made;
determining an outcome based on a rank of winning when the player won the card game; and
beneficially change the outcome when the dealt card has a predetermined symbol.

7. A gaming method comprising:
dealing at least one card among plural cards to a player;
accumulatively storing a portion of a bet value in a bonus pool;
determining an outcome when the player won the card game; and
beneficially change the outcome to a pooled amount stored in the bonus pool when the dealt card has a predetermined symbol.

8. The gaming method according to claim 5, further comprising:
beneficially changing the outcome when the dealt card has a different color from another cards.
